(19) United States
(12) Patent Application Publication
(10) Pub. No.: US 2015/0155604 A1
(43) Pub. Date: Jun. 4, 2015

(54) SYSTEM AND METHOD FOR CONTROLLING PRECIPITATION AND DISSOLUTION OF REACTION-RELATED SUBSTANCE IN SECONDARY BATTERY

(71) Applicant: TOYOTA JIDOSHA KABUSHIKI KAISHA, Toyota-shi, Aichi-ken (JP)

(72) Inventors: Tetsuya Fuchimoto, Nagoya-shi (JP); Kenji Takahashi, Toyota-shi (JP); Shuji Tomura, Nagoya-shi (JP); Yasuki Hirota, Seto-shi (JP)

(73) Assignee: TOYOTA JIDOSHA KABUSHIKI KAISHA, Toyota-shi, Aichi-ken (JP)

(21) Appl. No.: 14/406,072

(22) PCT Filed: Jul. 2, 2013
(86) PCT No.: PCT/IB2013/001396

§ 371 Date: Dec. 5, 2014

(30) Foreign Application Priority Data
Jul. 6, 2012 (JP) 2012-152349

(51) Int. Cl. H01M 10/42; H02J 7/00; H01M 16/00

(52) U.S. Cl. CPC H01M 10/4242; H01M 16/00; H02J 7/0054; H01M 10/052

(57) ABSTRACT

A system for controlling precipitation and dissolution of a reaction-related substance that is a substance relating to a battery reaction in a secondary battery and that includes a first electrical storage device, a second electrical storage device and a controller. The first electrical storage device is the secondary battery. The second electrical storage device is different from the first electrical storage device. The controller is configured to control an exchange of electric power between the first electrical storage device and the second electrical storage device. The controller is configured to, when the reaction-related substance has precipitated on a negative electrode of the first electrical storage device, charge the second electrical storage device with at least part of electric power that is discharged from the first electrical storage device. Thus, the controller raises a potential of the negative electrode to a potential higher than a potential of the reaction-related substance.

### BACKGROUND OF THE INVENTION

1. Field of the Invention

The invention relates to a system and method for controlling precipitation and dissolution of a reaction-related substance in a secondary battery. Specifically, the invention relates to a system and method for controlling precipitation and dissolution of a reaction-related substance in a secondary battery, which are able to suppress a decrease in a full-charge capacity of the secondary battery due to precipitation of the reaction-related substance in a negative electrode of the battery. More specifically, the invention relates to a system and method for controlling precipitation and dissolution of a reaction-related substance in a secondary battery, which are able to suppress a decrease in a full-charge capacity of the secondary battery, such as a lithium ion battery, by promptly dissolving the reaction-related substance after the reaction-related substance has been precipitated on a negative electrode of the battery with no waste of electric power stored in the battery.

2. Description of Related Art

In response to rising consciousness about energy-saving and global environment protection in recent years, for example, an electromotive vehicle, such as an electric vehicle (EV) and a hybrid vehicle (HV), has been coming into widespread. Accordingly, as a power supply for a motor that is a power source of the electromotive vehicle, development of, for example, a secondary battery, such as a lithium ion battery, has been actively conducted.

In general, one of inconveniences of a secondary battery, such as a lithium ion battery, is that a reaction-related substance relating to a battery reaction precipitates at the time when a negative electrode potential becomes lower than or equal to the potential of the reaction-related substance. For example, in a lithium ion battery, the reaction-related substance is lithium, and, when the negative electrode potential becomes lower than or equal to the potential of lithium (0 (zero) V on a metallic lithium basis), metallic lithium precipitates on the negative electrode.

The thus precipitated metallic lithium exhibits a potential lower than a decomposition potential (around 0.8 V on a metallic lithium basis) of an electrolyte solution (for example, ethylene carbonate (EC), diethyl carbonate (DEC), or the like) of the lithium ion battery. As a result, it is known that, due to the reaction between precipitated metallic lithium and the electrolyte solution, the electrolyte solution decomposes and the metallic lithium changes into an inert lithium oxide (see Morphological Transitions on Lithium Metal Anodes (Carmen M. Lopez, John T. Vaughey, and Dennis W. Dees), Journal of The Electrochemical Society, Volume 156, Issue 9, pp. A726 to A729 (2009)). The thus produced inert lithium oxide no longer contributes to the battery reaction, with the result that the full-charge capacity of the lithium ion battery irreversibly decreases.

Meanwhile, a portion of the precipitated metallic lithium, which has not changed into an inert lithium oxide unlike the above, for example, dissolves when the negative electrode potential becomes higher than or equal to the potential of lithium, as shown in FIG. 1, and contributes to the battery reaction again. FIG. 1 is a schematic graph that shows the correlation between the negative electrode potential and precipitation and dissolution of lithium in the lithium ion battery. As shown in the graph of FIG. 1, the negative electrode potential is higher than or equal to 0 (zero) V even at an open circuit voltage in a no load state, so lithium gradually dissolves. In this way, in order to suppress an irreversible decrease in the full-charge capacity of a secondary battery, such as a lithium ion battery, due to precipitation of a reaction-related substance in the negative electrode of the secondary battery, it is important to dissolve the precipitated reaction-related substance again by raising the negative electrode potential before the precipitated reaction-related substance becomes inactivated.

In this technical field, a technique has been suggested for dissolving a precipitated reaction-related substance by controlling a negative electrode potential to raise the negative electrode potential when the reaction-related substance has precipitated. Specifically, a technique has been suggested for, for example, in a lithium secondary battery, dissolving precipitated lithium dendrite by raising a negative electrode potential through a discharge from the lithium secondary battery to a discharging resistor or a load, such as a motor, or application of counter voltage to the lithium secondary battery with the use of an external power supply when the precipitation amount of lithium dendrite becomes larger than or equal to an allowable amount (for example, see Japanese Patent Application Publication No. 2009-199934 (JP 2009-199934 A)).

However, if a discharge is carried out from the lithium secondary battery to the discharging resistor as described above, electric power stored in the secondary battery goes to waste. In addition, a discharge from the secondary battery to a load, such as a motor, depends on a state of a load (for example, an operating situation, or the like, of an electromotive vehicle), so it is not always possible to promptly carry out a discharge at necessary timing. Furthermore, in order to apply counter voltage to the secondary battery with the use of an external power supply, for example, when the secondary battery is mounted on an electromotive vehicle, it is required to stop the electromotive vehicle at a location at which the external power supply is provided and to connect the electromotive vehicle to the external power supply. Thus, in such a case, there is a possibility that counter voltage is applied to the secondary battery with the use of the external power supply after a lapse of a long period of time from precipitation of lithium. Metallic lithium promptly starts reacting with an electrolyte solution after precipitation, so there is a possibility that, even when the negative electrode potential of the secondary battery is raised by applying counter voltage to the secondary battery after a lapse of a long period of time as described above, deactivation of metallic lithium has already proceeded at that point in time and, as a result, it is not possible to sufficiently dissolve the precipitated metallic lithium (for example, see Morphological Transitions on Lithium Metal Anodes (Carmen M. Lopez, John T. Vaughey, and Dennis W. Dees), Journal of The Electrochemical Society, Volume 156, Issue 9, pp. A726 to A729 (2009)).

In addition, in this technical field, a secondary battery is charged with excessive regenerative electric power (large-current pulse) in an electromotive vehicle. Regenerative electric power is, for example, generated as a result of switching between on/off states of an accelerator, a change in the rotation condition of a motor between a slip state and a grip state of drive wheels, or the like, in an electromotive vehicle. A technique has been suggested for preventing an overcharge of the secondary battery (and precipitation of metallic lithium due to an overcharge) by promptly carrying out a discharge to a load, such as a motor, at this time (for example, see Japanese Patent Application Publication No. 2009-278745 (JP 2009-278745 A)). However, in this case as well, a discharge to a load, such as a motor, depends on a state of a load (for example, the operating condition, or the like, of the electromotive vehicle), so it is not always possible to promptly carry out a discharge at necessary timing.

On the other hand, technically, for example, the following method is also possible in a hybrid power supply that combines a lithium ion battery with another auxiliary power supply. For example, flow of excessive charging current to a lithium ion battery is prevented by controlling the charging current that is supplied to the lithium ion battery through, for example, reception of the charging current with the use of the auxiliary power supply, thus completely suppressing precipitation of metallic lithium. However, in this technical field, it is known that, if precipitation of metallic lithium is completely suppressed, the utilization factor of regenerative electric power contrarily decreases as compared to the case where precipitation of metallic lithium is allowed. That is, it is possible to obtain a higher utilization factor of regenerative electric power when precipitation of metallic lithium is allowed to some degree. As a result, for example, in an HV, it is expected to improve total fuel economy and a travel distance in EV mode in which the HV travels with the use of only a motor as a power source without using an engine as a power source.

As described above, in this technical field, a technique has been required for, in a secondary battery, such as a lithium ion battery, making it possible to suppress a decrease in the full-charge capacity of the battery by promptly dissolving a reaction-related substance precipitated on a negative electrode of the battery after precipitation with no waste of stored electric power.

### SUMMARY OF THE INVENTION

The invention provides a system and method for suppressing a decrease in the full-charge capacity of a secondary battery, such as a lithium ion battery, by promptly dissolving a reaction-related substance precipitated on a negative electrode of the battery after precipitation.

An aspect of the invention provides a system for controlling precipitation and dissolution of a reaction-related substance that is a substance relating to a battery reaction in a secondary battery and that includes a first electrical storage device, a second electrical storage device and a controller. The first electrical storage device is the secondary battery. The second electrical storage device is different from the first electrical storage device. The controller is configured to control an exchange of electric power between the first electrical storage device and the second electrical storage device. The controller is configured to charge the second electrical storage device with at least part of electric power that is discharged from the first electrical storage device, when the reaction-related substance has precipitated on a negative electrode of the first electrical storage device. With this, the controller raises a potential of the negative electrode of the first electrical storage device to a potential higher than a potential of the reaction-related substance.

The another aspect of the invention provides a method for controlling precipitation and dissolution of a reaction-related substance that is a substance relating to a battery reaction of a secondary battery. In this method, when the reaction-related substance has precipitated on a negative electrode of a first electrical storage device that is the secondary battery, raising a potential of the negative electrode of the first electrical storage device to a potential higher than a potential of the reaction-related substance by charging a second electrical storage device, different from the first electrical storage device. The second electrical storage device is charged with at least part of electric power that is discharged from the first electrical storage device.

According to the invention it is possible to suppress waste of electric power stored in the battery and to suppress a decrease in the full-charge capacity of a secondary battery, such as a lithium ion battery, by promptly dissolving a reaction-related substance after the reaction-related substance has precipitated on a negative electrode of the battery.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic graph that shows the correlation between a negative electrode potential and precipitation and dissolution of lithium in a lithium ion battery;

FIG. 2 is a schematic circuit diagram that shows the configuration of a system for controlling precipitation and dissolution of a reaction-related substance in a first electrical storage device according to the embodiment of the invention and flow of electric power supplied in a normal state;

FIG. 3 is a schematic graph that shows a state of fluctuations in electric power (P1 and P2) from the first electrical storage device B1 and a second electrical storage device B2 as a result of fluctuations in load electric power PM;

FIG. 4 is a schematic circuit diagram that shows flow of electric power supplied during dissolution control that is executed in a reaction-related substance precipitation and dissolution control system (hereinafter, control system) according to the embodiment of the invention;

FIG. 5A is a schematic graph that shows changes in load electric power PM as a result of execution of dissolution control in the control system according to the embodiment of the invention;

FIG. 5B is a schematic graph that shows changes in electric power P1 that is supplied from the first electrical storage device B1 as a result of execution of dissolution control in the control system according to the embodiment of the invention;

FIG. 5C is a schematic graph that shows changes in negative electrode potential of the first electrical storage device B1 as a result of execution of dissolution control in the control system according to the embodiment of the invention;

FIG. 5D is a schematic graph that shows changes in electric power P2 that is supplied from the second electrical storage device B2 as a result of execution of dissolution control in the control system according to the embodiment of the invention; and

FIG. 6 is a flowchart that illustrates flow of various processes that are included in dissolution control that is executed in the control system according to the embodiment of the invention.

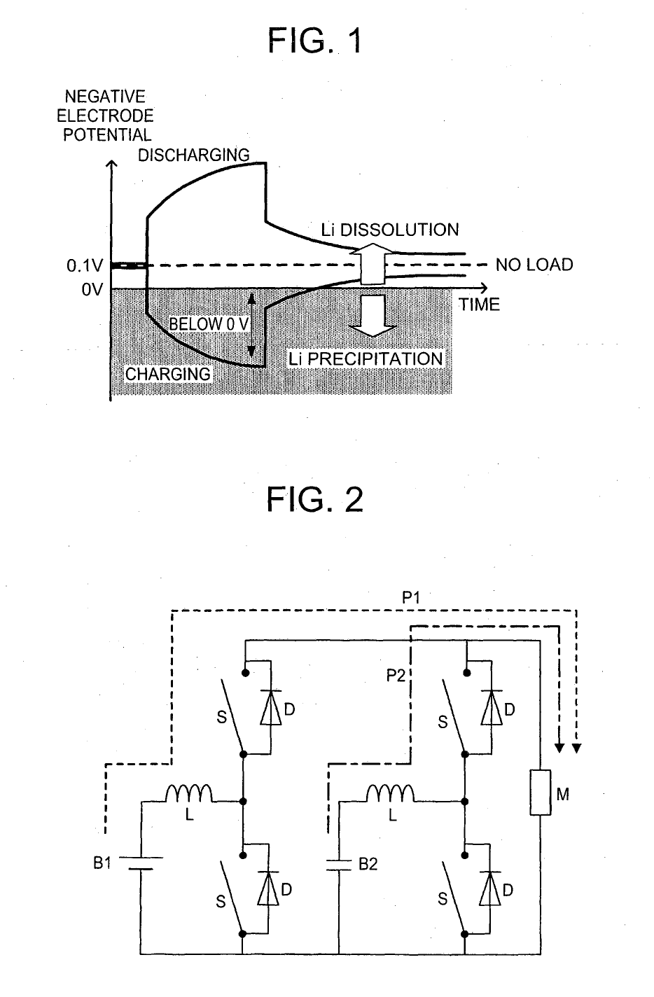

### DETAILED DESCRIPTION OF EMBODIMENTS

As described above, the invention suppresses a decrease in a full-charge capacity of a secondary battery, such as a lithium ion battery, by promptly dissolving a reaction-related substance after the reaction-related substance has precipitated on a negative electrode of the battery with no waste of electric power stored in the battery. The inventor, as a result of diligent research for achieving the above, found the following and conceived of the invention. That is, an auxiliary electrical storage device other than the secondary battery is further provided, and, when the reaction-related substance has precipitated on the negative electrode of the secondary battery, a discharge is carried out from the secondary battery to the auxiliary electrical storage device. With this, it is possible to promptly dissolve the reaction-related substance precipitated on the negative electrode of the secondary battery by raising the negative electrode potential of the secondary battery with no waste of electric power stored in the secondary battery.

A system according to a first embodiment of the invention is a system for controlling precipitation and dissolution of a reaction-related substance that is a substance relating to a battery reaction in a secondary battery and that includes a first electrical storage device, a second electrical storage device and a controller. The first electrical storage device is the secondary battery. The second electrical storage device is different from the first electrical storage device. The controller is configured to control an exchange of electric power between the first electrical storage device and the second electrical storage device. The controller is configured to, when the reaction-related substance has precipitated on a negative electrode of the first electrical storage device, charge the second electrical storage device with at least part of electric power that is discharged from the first electrical storage device. With this, the controller raises a potential of the negative electrode of the first electrical storage device to a potential higher than a potential of the reaction-related substance.

As described above, the system according to the present embodiment is a system that controls precipitation and dissolution of the reaction-related substance that is a substance relating to a battery reaction in the first electrical storage device that is the secondary battery. As is apparent to persons skilled in the art, the secondary battery is a battery (also referred to as “chargeable battery” or “storage battery”) that is able to be used as a battery by storing electric power through charging and that is able to be repeatedly used through recharging even when stored electric power is discharged. Charging and discharging of the secondary battery are, for example, performed by utilizing an exchange of electrons as a result of an oxidation-reduction reaction of a substance, such as a metal. In the specification, a substance that relates to the battery reaction and that contributes to charging and discharging of the battery is referred to as “reaction-related substance”. A specific configuration of the secondary battery to which the system according to the present embodiment is applied is not specifically limited.

However, as described above, the invention attempts to suppress a decrease in the full-charge capacity of the secondary battery, such as a lithium ion battery, by promptly dissolving a reaction-related substance after the reaction-related substance has precipitated on the negative electrode of the battery with no waste of electric power stored in the battery. Thus, the above-described secondary battery is a secondary battery in which the reaction-related substance can precipitate on the negative electrode when the potential of the negative electrode has decreased, for example, during charging, or the like. A specific example of the secondary battery may be, for example, a lithium ion battery. For the configuration of the lithium ion battery, for example, aluminum (Al) may be used as a positive electrode current collector, copper (Cu) may be used as a negative electrode current collector, and, for example, ethylene carbonate (EC), diethyl carbonate (DEC), or the like, may be used as an electrolyte.

In the secondary battery, typically, the above-described lithium ion battery, when the negative electrode potential becomes lower than or equal to the potential of the reaction-related substance, the reaction-related substance precipitates on the negative electrode. For example, in the lithium ion battery, when the negative electrode potential becomes lower than or equal to the potential (0 V) of lithium, metallic lithium precipitates on the negative electrode. Thus, due to the reaction between the precipitated metallic lithium and the electrolyte solution, the electrolyte solution decomposes and the metallic lithium changes into an inert lithium oxide. The inert lithium oxide no longer contributes to the battery reaction, with the result that the full-charge capacity of the lithium ion battery irreversibly decreases.

Meanwhile, a portion of the precipitated metallic lithium, which has not changed into an inert lithium oxide unlike the above, dissolves when the negative electrode potential becomes higher than or equal to the potential of lithium, and contributes to the battery reaction again. In this way, in order to suppress an irreversible decrease in the full-charge capacity of a secondary battery due to precipitation of a reaction-related substance in the negative electrode of the secondary battery, it is important to dissolve the precipitated reaction-related substance again by raising the negative electrode potential before the precipitated reaction-related substance becomes inactivated.

In this technical field, a technique is known for, for example, when the precipitation amount of dendrite of lithium that is the reaction-related substance becomes larger than or equal to an allowable amount in the lithium secondary battery, dissolving the dendrite with the following method. For example, the method is to raise the negative electrode potential by carrying out a discharge from the lithium secondary battery to a discharging resistor or a load, such as a motor, or applying counter voltage to the lithium secondary battery with the use of an external power supply. However, when a discharge to the charging resistor is carried out, electric power stored in the secondary battery goes to waste. In addition, when a discharge to a load, such as a motor is carried out, or when counter voltage is applied with the use of the external power supply, it is not always possible to promptly carry out a discharge depending on a state of a load (for example, the operating condition, or the like, of an electromotive vehicle) or an installation condition of the external power supply. When it is not possible to promptly carry out a discharge, there is a concern that deactivation of metallic lithium proceeds during then and it is not possible to sufficiently dissolve precipitated metallic lithium.

Then, in the system according to the present embodiment, the auxiliary electrical storage device other than the secondary battery is further provided, and, when the reaction-related substance has precipitated on the negative electrode of the secondary battery, a discharge is carried out from the secondary battery to the auxiliary electrical storage device. With this, it is possible to promptly dissolve the reaction-related substance precipitated on the negative electrode of the secondary battery by raising the negative electrode potential of the secondary battery with no waste of electric power stored in the secondary battery.

Specifically, the system according to the present embodiment that includes a first electrical storage device, a second electrical storage device and a controller. The first electrical storage device is the secondary battery. The second electrical storage device is different from the first electrical storage device. The controller is configured to control an exchange of electric power between the first electrical storage device and the second electrical storage device. The controller is configured to, when the reaction-related substance has precipitated on a negative electrode of the first electrical storage device, charge the second electrical storage device with at least part of electric power that is discharged from the first electrical storage device. With this, the controller raises a potential of the negative electrode of the first electrical storage device to a potential higher than a potential of the reaction-related substance. Thus, with the system according to the present embodiment, it is possible to promptly dissolve the reaction-related substance precipitated on the negative electrode of the first electrical storage device.

The second electrical storage device may have any configuration as long as the second electrical storage device is able to receive electric power stored in the first electrical storage device and stores the received electric power, and is not limited to a specific configuration. A specific example of the second electrical storage device may be, for example, a secondary battery, a capacitor, or the like. In addition, the second electrical storage device may be configured to supply electric power to a load, such as a motor, in addition to the above-described configuration. Furthermore, the second electrical storage device may be configured to supply electric power to a load, such as a motor, together with the first electrical storage device.

The controller may have any configuration as long as the controller is able to control an exchange of electric power between the first electrical storage device and the second electrical storage device, and is not limited to a specific configuration. In addition, when the specifications of electric power (for example, voltage, or the like) are different between the first electrical storage device and the second electrical storage device, the controller may have a function of converting the specifications of electric power stored in the first electrical storage device to the specifications of electric power, appropriate for the second electrical storage device. A specific example of the controller is to include a power converter, such as a converter.

With the system according to the present embodiment, when the reaction-related substance has precipitated on a negative electrode of the first electrical storage device, charge the second electrical storage device with at least part of electric power that is discharged from the first electrical storage device. With this, the controller raises a potential of the negative electrode of the first electrical storage device to a potential higher than a potential of the reaction-related substance. Here, determination as to whether the reaction-related substance has precipitated on the negative electrode of the first electrical storage device may be, for example, carried out on the basis of the result of comparison between the potential of the negative electrode, which is measured or estimated (calculated), and the potential of the reaction-related substance. A single electrode potential of a positive electrode or negative electrode in the battery may be, for example, measured on the basis of a potential difference from a reference electrode provided in the battery or estimated using a battery model based on an electrochemical reaction formula.

As an example of a method of determining whether the reaction-related substance has precipitated, the negative electrode potential is directly measured by providing a reference electrode in the first electrical storage device and, when the measured value of the negative electrode potential is lower than or equal to the potential of the reaction-related substance, it is possible to determine that the reaction-related substance has precipitated. In the case where the reference electrode is composed of the same substance (for example, lithium) as the reaction-related substance, when the measured value of the negative electrode potential is lower than or equal to 0 (zero) V, it may be determined that the reaction-related substance has precipitated.

Furthermore, in another embodiment, the negative electrode potential is calculated on the basis of the voltage, current and temperature of the secondary battery that constitutes the first electrical storage device and, when the thus calculated negative electrode potential is lower than or equal to the potential of the reaction-related substance, it may be determined that the reaction-related substance has precipitated. In this case, for example, the negative electrode potential may be estimated by utilizing a battery model based on an electrochemical reaction formula (for example, see Japanese Patent Application Publication No. 2008-042960 (JP 2008-042960 A)).

Alternatively, it may be, determined whether the reaction-related substance has precipitated on the basis of the history of current that flows through the first electrical storage device (current history). For example, the first electrical storage device to which the invention is applied is used as a power supply of a motor that is mounted on an electromotive vehicle as a power source, the above-described determination may be carried out on the basis of regenerative electric power. Specifically, the above-described determination may be carried out at the time when excessive regenerative current (large-current pulse) has occurred. Excessive regenerative current occurs as a result of, for example, switching of on/off states of an accelerator in the electromotive vehicle, a change in the rotation condition of the motor between a slip state and a grip state of drive wheels, or the like. A specific technique for determining whether the reaction-related substance has precipitated on the negative electrode of the first electrical storage device is not limited to the above one.

As described above, with the system according to the present embodiment, when the reaction-related substance has precipitated on a negative electrode of the first electrical storage device, charge the second electrical storage device with at least part of electric power that is discharged from the first electrical storage device. With this, the controller raises a potential of the negative electrode of the first electrical storage device to a potential higher than a potential of the reaction-related substance. That is, the system according to the present embodiment is able to promptly carry out a discharge from the first electrical storage device at necessary timing irrespective of a state of a load (for example, the operating condition, or the like, of the electromotive vehicle when the load is the motor) that receives electric power supplied from the first electrical storage device. Thus, the system according to the present embodiment is able to promptly dissolve the reaction-related substance precipitated on the negative electrode of the first electrical storage device.

In addition, the system according to the present embodiment does not discharge electric power stored in, the first electrical storage device to a discharging resistor unlike the above-described related art but is able to use the electric power for charging the second electrical storage device and to store the electric power in the second electrical storage device. Thus, with the system according to the present embodiment, it is possible to suppress waste of electric power stored in the first electrical storage device except a circuit loss and a charge/discharge loss. As described above, with the system according to the present embodiment, in the secondary battery, such as a lithium ion battery, it is possible to suppress waste of stored electric power and to suppress a decrease in the full-charge capacity of the battery by promptly dissolving the reaction-related substance precipitated on the negative electrode of the battery after precipitation.

Here, the system according to the present embodiment and a method for controlling precipitation and dissolution of the reaction-related substance in the first electrical storage device will be described in detail with reference to the accompanying drawings. First, FIG. 2 is a schematic circuit diagram that shows the configuration of the system for controlling precipitation and dissolution of a reaction-related substance (hereinafter, also referred to as “reaction-related substance precipitation and dissolution control system” or “control system” where appropriate) in the first electrical storage device according to one embodiment of the invention and flow of electric power (power flow) supplied in a normal state.

The reaction-related substance precipitation and dissolution control system (control system) according to the embodiment shown in FIG. 2 is a system that controls precipitation and dissolution of the reaction-related substance that is a substance relating to the battery reaction in a first electrical storage device B1 that is a secondary battery. The control system further includes a second electrical storage device B2 different from the first electrical storage device B1 and controllers that control an exchange of electric power between the first electrical storage device B1 and the second electrical storage device B2. The controllers charge the second electrical storage device B2 with at least part of electric power that is discharged from the first electrical storage device B1 when the reaction-related substance has precipitated on the negative electrode of the first electrical storage device B1. With this, the potential of the negative electrode of the first electrical storage device B1 is raised to a potential higher than the potential of the reaction-related substance.

As shown in FIG. 2, in the control system according to the present embodiment, each of the first electrical storage device B1 and the second electrical storage device B2 is connected to a load M (for example, a motor, or the like) via the corresponding controller. Each controller includes a step-up converter that includes a switching element S, a rectifying element D (for example, diode, or the like) and an inductance element L. However, the configuration of the control system shown in FIG. 2 is just illustrative. For example, the configuration of each controller is not limited to the configuration shown in FIG. 2, but it may be any configuration as long as it is possible to control an exchange of electric power between the first electrical storage device B1 and the second electrical storage device B2.

First, a state (hereinafter, simply referred to as “normal state” where appropriate) where control (hereinafter, simply referred to as “dissolution control” where appropriate) for raising the potential of the negative electrode of the first electrical storage device. B1 to a potential higher than the potential of the reaction-related substance in order to dissolve the reaction-related substance precipitated on the negative electrode of the first electrical storage device B1 is not executed will be described. In this normal state, it is possible to supply electric power PM that is consumed in the load M by using electric power P1 that is supplied from the first electrical storage device B1 (indicated by the dotted-line arrow in FIG. 2) and electric power P2 that is supplied from the second electrical storage device B2 to the load M (indicated by the alternate long and short dashed-line arrow in FIG. 2).

In this case, the ratio of each of the electric power P1 and the electric power P2 with respect to the electric power PM that is consumed in the load M may be set as needed on the basis of, for example, the amount of electric power that is stored in each of the electrical storage devices. In addition, for example, the controller for the first electrical storage device B1 is subjected to current control, the controller for the second electrical storage device B2 is subjected to voltage control, and the battery current of the first electrical storage device B1 is controlled so as to attain a desired value. Thus, it is possible to control the electric power P1 and the electric power P2. In this case, for example, when losses in the controllers, such as converter losses, are ignored, the relationship shown in the following mathematical expression (1) holds among the electric powers PM, P1, P2.

PM=P1+P2 (1)

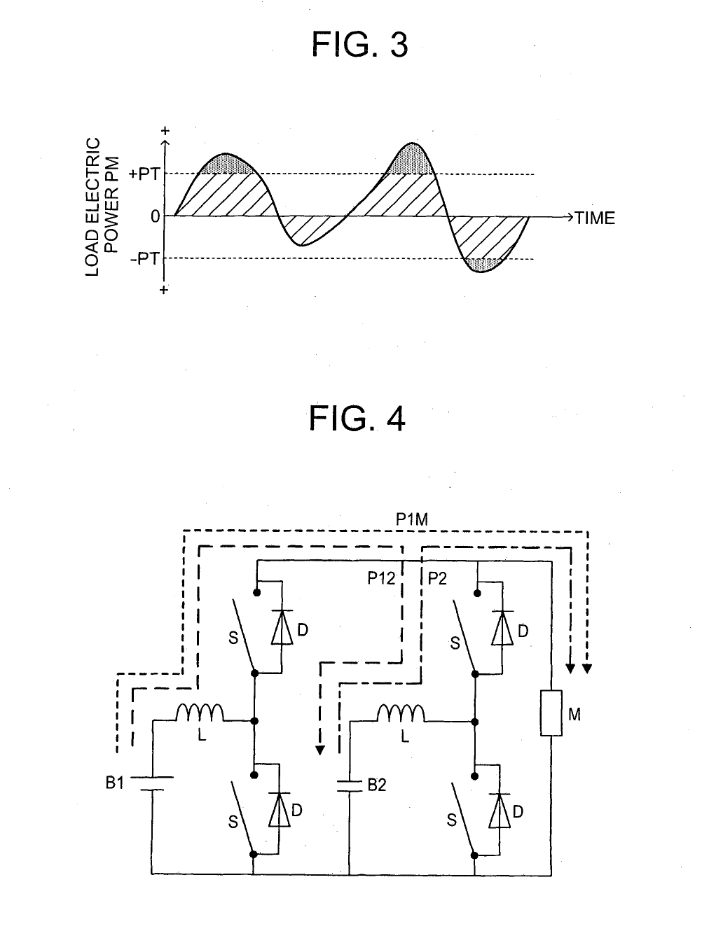

Description will be made on the case where the controllers control the first electrical storage device B1 and the second electrical storage device B2, supply the electric power P1 for the electric power PM that is consumed in the load (hereinafter, referred to as “load electric power” where appropriate) until a predetermined threshold electric power (PT) and supply the electric power P2 for electric power exceeding the threshold electric power PT. The electric power (P1 and P2) from the first electrical storage device B1 and the second electrical storage device B2 as a result of fluctuations in the load electric power PM, for example, fluctuates as shown in the graph of FIG. 3. FIG. 3 is a schematic graph that shows a state of fluctuations, in electric power (P1 and P2) from the first electrical storage device B1 and the second electrical storage device B2 as a result of fluctuations in the load electric power PM. As shown in FIG. 3, when the absolute value of the load electric power PM is lower than or equal to the threshold electric power PT, it is possible to provide for the load electric power PM by using only the electric power P1 from the first electrical storage device B1. On the other hand, when the absolute value of the load electric power PM exceeds the threshold electric power PT, it is possible to provide for the electric power corresponding to the threshold electric power PT by using the electric power P1 from the first electrical storage device B1 (which corresponds to the positive shaded area in FIG. 3) and to provide for the electric power exceeding the threshold electric power PT by using the electric power P2 from the second electrical storage device B2 (which corresponds to the hatched area in FIG. 3).

Next, the state where dissolution control is executed will be described with reference to FIG. 4. FIG. 4 is a schematic circuit diagram that shows power flow at the time when dissolution control is executed in the control system according to the embodiment of the invention. During dissolution control, in order to dissolve the reaction-related substance precipitated on the negative electrode of the first electrical storage device B1, control for raising the potential of the negative electrode of the first electrical storage device B1 to a potential higher than the potential of the reaction-related substance is executed by the controllers. Specifically, as shown in FIG. 4, the electric power P1 that is supplied from the first electrical storage device B1 is separated into an electric power P1M (indicated by the dotted-line arrow in FIG. 4) that is supplied to the load M and an electric power P12 (indicated by the broken-line arrow in FIG. 4) that is supplied to the second electrical storage device B2. It is possible to supply the electric power PM to be consumed in the load M by using the electric power PIM and the electric power P2 (indicated by the alternate long and short dashed-line arrow in FIG. 2) that is supplied from the second electrical storage device B2 to the load M. The relationship among these electric powers may be expressed by the following mathematical expressions (2).

P1=P1M+P12

PM=P1M+P2 (2)

The load electric power PM is small at the time when it is determined that the reaction-related substance has precipitated on the negative electrode and, as a result, there can occur a case where it is not possible to increase the electric power P1M to a sufficiently large value for dissolving the precipitated reaction-related substance. However, as is apparent from the mathematical expressions (2), it is possible to increase the electric power P1, which is supplied from the first electrical storage device B1, to a desired value at desired timing by increasing the electric power P1M and the electric power P12. That is, in the above-described case as well, it is possible to increase the electric power P1M to a sufficiently large value for dissolving the precipitated reaction-related substance by increasing the electric power P12.

As described, the control system according to the present embodiment is able to dissolve the precipitated reaction-related substance again by promptly raising the negative electrode potential at the time when the reaction-related substance has precipitated on the negative electrode of the first electrical storage device B1. Thus, it is possible to suppress an irreversible decrease in the full-charge capacity of the first electrical storage device B1 caused by deactivation due to, for example, the reaction of the reaction-related substance, precipitated on the negative electrode of the first electrical storage device B1, with the electrolyte solution. In addition, it is possible to charge the second electrical storage device B2 with electric power discharged from the first electrical storage device B1 for dissolution control, so, unlike the system according to the related art, it is possible to basically suppress waste of electric power stored in the first electrical storage device except, for example, a circuit loss and a charge/discharge loss.

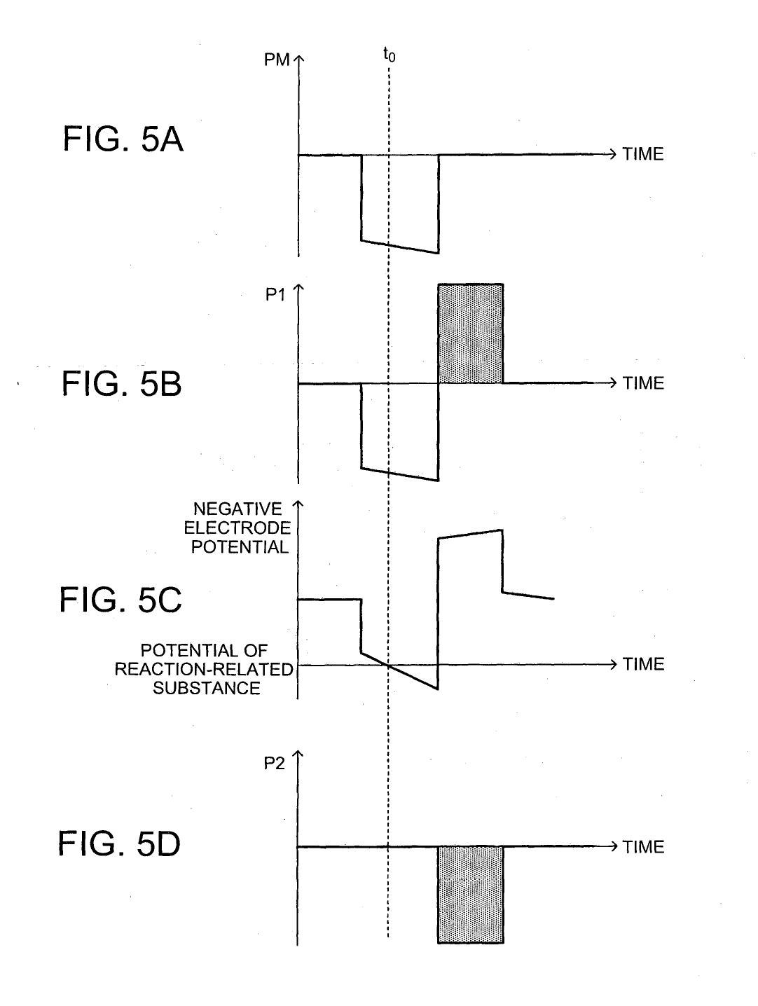

Here, changes of the load electric power PM, the electric power P1 that is supplied from the first electrical storage device B1, the negative electrode potential of the first electrical storage device B1 and the electric power P2 that is supplied from the second electrical storage device B2 as a result of execution of dissolution control in the control system according to the present embodiment will be described with reference to the accompanying drawings. FIG. 5A is a schematic graph that shows changes of the load electric power PM. FIG. 5B is a schematic graph that shows changes of the electric power P1. FIG. 5C is a schematic graph that shows changes of the negative electrode potential of the first electrical storage device B1. FIG. 5D is a schematic graph that shows changes of the electric power P2.

First, as shown in FIG. 5A, electric power is generated from the load during a certain period. For example, when the load is a motor, regenerative electric power is being generated during the period. During the period, as shown in FIG. 5B, the first electrical storage device B1 is charged with the electric power that is generated from the load in this way, and, as shown in FIG. 5C, the potential of the negative electrode of the first electrical storage device B1 decreases. At time t₀, the potential of the negative electrode of the first electrical storage device B1 starts becoming lower than the potential of the reaction-related substance (for example, lithium, or the like). That is, in the negative electrode of the first electrical storage device B1, the reaction-related substance (for example, metallic lithium) begins to precipitate.

Then, after charging of the first electrical storage device B1 with the electric power that is generated from the load has been completed, the first electrical storage device B1 is discharged as shown by the hatched area in FIG. 5B. As shown in a period, corresponding to the hatched area of FIG. 5B, in FIG. 5C, the controllers raise the potential of the negative electrode of the first electrical storage device B1. Thus, in the control system according to the present embodiment, the precipitated reaction-related substance is dissolved again by promptly raising the negative electrode potential at the time when the reaction-related substance has precipitated on the negative electrode of the first electrical storage device B1. With this, it is possible to suppress an irreversible decrease in the full-charge capacity of the first electrical storage device B1 caused by deactivation due to, for example, the reaction of the precipitated reaction-related substance with the electrolyte solution.

The electric power that is discharged from the first electrical storage device. B1, which is indicated by the hatched area in FIG. 5B, is not supplied to the load as shown in FIG. 5A but is supplied to the second electrical storage device B2 as shown in FIG. 5D and is used to charge the second electrical storage device B2. Thus, in the control system according to the present embodiment, unlike the system according to the related art, it is possible to basically suppress waste of electric power stored in the first electrical storage device except, for example, a circuit loss and a charge/discharge loss.

As described above, with the control system according to the present embodiment, it is possible to suppress a decrease in the full-charge capacity of a secondary battery, such as a lithium ion battery, by promptly dissolving the reaction-related substance precipitated on the negative electrode of the battery after precipitation with no waste of stored electric power.

The above description is made on the example in which all the electric power P1 is used to charge the second electrical storage device B2; instead, the electric power P1 may be distributed into P1M that is supplied to the load M and P12 that is supplied to the second electrical storage device as expressed by the mathematical expressions (2).

Incidentally, a specific configuration of the secondary battery that constitutes the first electrical storage device is not specifically limited. The invention attempts to suppress a decrease in the full-charge, capacity of the secondary battery, such as a lithium ion battery, by promptly dissolving a reaction-related substance after the reaction-related substance has precipitated on the negative electrode of the battery with no waste of electric power stored in the battery. Thus, the secondary battery to which the invention is applied is a secondary battery in which the reaction-related substance can precipitate on the negative electrode when the potential of the negative electrode has decreased, for example, during charging, or the like. A specific example of the secondary battery may be, for example, a lithium ion battery.

Thus, a system according to a second embodiment of the invention is the system according to the first embodiment of the invention and the secondary battery, that is, the first electrical storage device, is a lithium ion battery.

As described above, in the lithium ion battery, when the negative electrode potential becomes lower than or equal to the potential (0 V) of lithium, metallic lithium precipitates on the negative electrode. Thus, due to the reaction between the precipitated metallic lithium and the electrolyte solution (for example, ethylene carbonate (EC), diethyl carbonate (DEC), or the like), the electrolyte solution decomposes and the metallic lithium changes into an inert lithium oxide. The inert lithium oxide no longer contributes to the battery reaction, with the result that the full-charge capacity of the lithium ion battery irreversibly decreases.

On the other hand, a portion of the precipitated metallic lithium, which has not changed into an inert lithium oxide, dissolves when the negative electrode potential becomes higher than or equal to the potential of lithium, and contributes to the battery reaction again. In this way, in order to suppress an irreversible decrease in the full-charge capacity of the lithium ion battery due to precipitation of metallic lithium on the negative electrode of the lithium ion battery, it is important to dissolve the precipitated metallic lithium again by raising the negative electrode potential before the precipitated metallic lithium becomes inactivated.

With the control system according to the present embodiment, it is possible to increase the electric power that is supplied from the first electrical storage device (lithium ion battery) to a desired value at desired timing and, in addition, to use the electric power to charge the second electrical storage device, so it is possible to suppress a decrease in the full-charge capacity of the lithium ion battery by prompting dissolving metallic lithium, precipitated on the negative electrode of the lithium ion battery, after precipitation with no waste of electric power stored in the lithium ion battery.

Incidentally, in the invention, when the reaction-related substance has precipitated on a negative electrode of a secondary battery, such as a lithium ion battery, a potential of the negative electrode of the battery is raised to a potential higher than a potential of the reaction-related substance by discharging the battery, and the reaction-related substance is promptly dissolved after precipitation. Thus, the invention provides a system for suppressing a decrease in the full-charge capacity of the battery. In addition, in the control system according to the invention, electric power that is discharged from the secondary battery (first electrical storage device) is used to charge the electrical storage device (second electrical storage device) other than the secondary battery. At this time, when the second electrical storage device is a secondary battery, there is a possibility that a secondary reaction, such as precipitation of a reaction-related substance on a negative electrode, occurs in the second electrical storage device as in the case of the above. Thus, the second electrical storage device is desirably an electrical storage device that is not a secondary battery.

That is, a system according to a third embodiment of the invention is the system according to the first or second embodiment of the invention and the second electrical storage device is a secondary battery in which precipitation of a reaction-related substance does not occur or an electrical storage device other than a secondary battery.

That is, the second electrical storage device of the control system according to the present embodiment, for example, does not utilize an exchange of electrons as a result of an oxidation-reduction reaction of a reaction-related substance, such as metal, in charging and discharging. Thus, in the second electrical storage device of the control system according to the present embodiment, unlike the first electrical storage device that is the secondary battery, the reaction-related substance (for example, lithium, or the like) does not precipitate on the negative electrode at the time when the negative electrode potential becomes lower than or equal to the potential of the reaction-related substance (for example, 0 (zero) V on a metallic lithium basis). A specific example of the electrical storage device may be, for example, a capacitor. Among capacitors, an electric double layer capacitor is particularly desirable.

Thus, a system according to a fourth embodiment of the invention is the system according to the third embodiment of the invention and the second electrical storage device is an electric double layer capacitor.

As described above, in the control system according to the present embodiment, the second electrical storage device is an electric double layer capacitor. As is known by persons skilled in the art, the electric double layer capacitor is a capacitor that has an extremely high electrical storage efficiency by utilizing a physical phenomenon called electric double layer. Thus, the control system according to the present embodiment has an advantage that no reaction-related substance (for example, lithium, or the like) precipitates on the negative electrode at the time when the negative electrode potential becomes lower than or equal to the potential of the reaction-related substance (for example, 0 (zero) V on a metallic lithium basis). In addition, the control system according to the present embodiment also has an advantage that it is possible to minimize an increase in size, or the like, due to additional provision of the second electrical storage device.

Incidentally, in the invention, when the reaction-related substance has precipitated on a negative electrode of a secondary battery, such as a lithium ion battery, a potential of the negative electrode of the battery is raised to a potential higher than a potential of the reaction-related substance by discharging the battery, and the reaction-related substance is promptly dissolved after precipitation. Thus, the invention provides a system for suppressing a decrease in the full-charge capacity of the battery. In the dissolution control, as the potential of the negative electrode rises, the dissolution rate of the precipitated reaction-related substance increases. Thus, only in terms of dissolving the precipitated reaction-related substance, the potential of the negative electrode during dissolution control is desirably higher.

However, usually, it is difficult to solely control only the negative electrode potential in a battery, and it is general that a battery voltage is actually set as a controlled object. Thus, when the first electrical storage device is discharged in order to raise the negative electrode potential, there is a concern that the potential of a positive electrode or negative electrode reaches a potential at which an undesirable secondary reaction (for example, dissolution of an electrode material, or the like) occurs in the positive or negative electrode. Such a secondary reaction leads to a decrease in the battery performance of the first electrical storage device, and, of course, it is desirable to prevent such a secondary reaction.

Thus, a system according to a fifth embodiment of the invention is the system according to any one of the first to fourth embodiments of the invention and the controllers keep the potential of the negative electrode or the potential of the positive electrode within a range in which a secondary reaction other than the battery reaction based on the reversible oxidation-reduction reaction of the reaction-related substance does not occur at the time of raising the potential of the negative electrode.

As described above, in the control system according to the present embodiment, the controllers keep the potential of the negative electrode and the potential of the positive electrode within a range in which a secondary reaction other than the battery reaction based on the reversible oxidation-reduction reaction of the reaction-related substance does not occur at the time of raising the potential of the negative electrode. With this, in the control system according to the present embodiment, by suppressing a decrease in the full-charge capacity of a secondary battery, such as a lithium ion battery, by promptly dissolving a reaction-related substance precipitated on the negative electrode of the battery after precipitation and keeping the potential of each of the negative electrode and the positive electrode within a proper range, it is possible to prevent occurrence of a secondary reaction as described above. The single electrode potential of each of the positive electrode and the negative electrode of the first electrical storage device may be, for example, measured on the basis of a potential difference from a reference electrode provided in the battery or estimated using a battery model based on an electrochemical reaction formula.

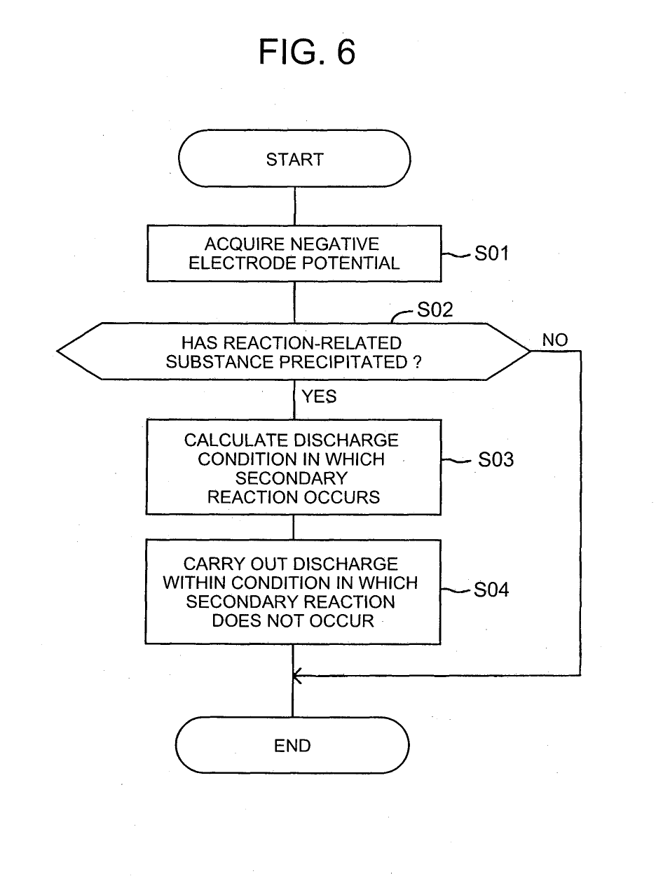

Here, flow of various processes that are included in dissolution control that is executed in a control system according to one alternative embodiment to the present embodiment will be described with reference to the flowchart shown in FIG. 6. As shown in FIG. 6, first, in step S01, the potential of the negative electrode is acquired. Specifically, the single electrode potential of the negative electrode of the first electrical storage device may be, for example, measured on the basis of a potential difference from a reference electrode provided in the battery or may be estimated from the voltage, current and temperature of the secondary battery that constitutes the first electrical storage device by utilizing a battery model based on an electrochemical reaction formula.

Subsequently, in step S02, it is determined whether precipitation of the reaction-related substance, such as precipitation of metallic lithium, has occurred on the basis of the negative electrode potential acquired in step S01. The control system according to the embodiment shown in FIG. 6 determines whether precipitation of the reaction-related substance has occurred on the basis of the single electrode potential of the negative electrode; instead, it may be determined whether the reaction-related substance has precipitated on the basis of a current history in the first electrical storage device. A specific technique for determining whether the reaction-related substance has precipitated on the negative electrode of the first electrical storage device is not limited to the above-described one.

When it is determined in step S02 that the reaction-related substance has not precipitated (No in step S02), it is not required to execute control for dissolving the reaction-related substance precipitated on the negative electrode by raising the potential of the negative electrode to a potential higher than the potential of the reaction-related substance through a discharge of the first electrical storage device (dissolution control). Therefore, the process routine is ended. On the other hand, when it is determined in step S02 that the reaction-related substance has precipitated (Yes in step S02), a discharge condition in which the potential of the positive electrode or negative electrode reaches a potential at which the above-described undesirable secondary reaction occurs is calculated in the next step S03.

After that, dissolution control is executed in step S04. However, the control system according to the present embodiment executes dissolution control (discharge the first electrical storage device) within the discharge condition calculated in step S03 such that the potential of each of the positive electrode and the negative electrode does not reach a potential at which a secondary reaction can occur at the time of executing dissolution control, and then the process routine is ended.

The control routine shown in the flowchart of FIG. 6 may be configured as follows, for example, when the first electrical storage device to which the invention is applied is used as a power supply of a motor that is mounted on an electromotive vehicle as a power source. Determination processes and computing processes corresponding to the processes in the control routine may be stored in, for example, a storage device (for example, a read-only memory (ROM), a random access memory (RAM), a hard disk drive (HDD), or the like) of an electronic control unit (ECU) mounted on the electromotive vehicle as a program that describes an algorithm to be executed on a central processing unit (CPU) of the ECU. In addition, the control routine shown in the flowchart of FIG. 6 may be configured to be repeatedly executed at sufficiently short time intervals in terms of necessary control accuracy, for example, utilizing a clock included in the ECU.

For the purpose of description of the invention, some embodiments having specific configurations are described. However, the scope of the invention is not limited to these illustrative embodiments, and, of course, may be modified as needed within the scope of matter described in the appended claims and the specification.

1. A system for controlling precipitation and dissolution of a reaction-related substance that is a substance relating to a battery reaction of a secondary battery, comprising:
a first electrical storage device that is the secondary battery;
a second electrical storage device that is different from the first electrical storage device; and
a controller configured to control an exchange of electric power between the first electrical storage device and the second electrical storage device,
the controller being configured to raise a potential of a negative electrode of the first electrical storage device to a potential higher than a potential of the reaction-related substance by charging the second electrical storage device with at least part of electric power that is discharged from the first electrical storage device, when the reaction-related substance has precipitated on the negative electrode of the first electrical storage device.

2. The system according to claim 1, wherein
the first electrical storage device is a lithium ion battery.

3. The system according to claim 1, wherein
the second electrical storage device is any one of a secondary battery, in which precipitation of the reaction-related substance does not occur, or an electrical storage device other than a secondary battery.

4. The system according to claim 3, wherein
the second electrical storage device is an electric double layer capacitor.

5. The system according to claim 1, wherein
the controller is configured to, when raising the potential of the negative electrode, keep the potential of the negative electrode and a potential of a positive electrode within a range in which a secondary reaction other than the battery reaction based on a reversible oxidation-reduction reaction of the reaction-related substance does not occur.

6. A method of controlling precipitation and dissolution of a reaction-related substance that is a substance relating to a battery reaction of a secondary battery, comprising:
when the reaction-related substance has precipitated on a negative electrode of a first electrical storage device that is the secondary battery, raising a potential of the negative electrode of the first electrical storage device to a potential higher than a potential of the reaction-related substance by charging a second electrical storage device, different from the first electrical storage device, with at least part of electric power that is discharged from the first electrical storage device.

7. The method according claim 6, wherein
when raising the potential of the negative electrode, the potential of the negative electrode and a potential of a positive electrode are kept within a range in which a secondary reaction other than the battery reaction based on a reversible oxidation-reduction reaction of the reaction-related substance does not occur.
